(19) United States
(12) Patent Application Publication
(10) Pub. No.: US 2004/0214541 A1
(43) Pub. Date: Oct. 28, 2004

(54) Apparatus and method for transmitting a television signal received in a mobile communication terminal

(76) Inventor: Taek-Kyun Choi, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/781,796

(22) Filed: Feb. 20, 2004

(30) Foreign Application Priority Data
Apr. 22, 2003 (KR) 2003-25383

(51) Int. Cl. H04B 1/18

(52) U.S. Cl. 455/186.1

(57) ABSTRACT

An apparatus and method for transmitting a signal of a moving image in a mobile communication terminal capable of reproducing the moving image. The apparatus includes an input section for generating signals for capturing and transmitting a moving image signal which is being reproduced; a control section for generating, according to the signals generated by the input section, a command signal for capture and transmission of the moving image signal which is being reproduced, the control section controlling the moving image signal to be displayed and simultaneously the displayed image to be captured and transmitted; a memory for storing the image captured according to a capture command generated by the control section; and a transmission section for transmitting the captured image stored in the memory.

### PRIORITY

This application claims priority to an application entitled “Apparatus and method for transmitting television signal received in mobile communication terminal” filed in the Korean Industrial Property Office on Apr. 22, 2003 and assigned Serial No. 2003-25383, the contents of which are incorporated herein by reference.

### BACKGROUND OF THE INVENTION

1. Field of the Invention

The present invention relates to a transmission apparatus and method employed in a mobile communication terminal, and more particularly to a transmission apparatus and method employed in a mobile communication terminal which receives a television signal.

2. Description of the Related Art

At present, mobile communication terminals have been developed to transmit high-speed data in addition to voice. That is, when a mobile communication network according to the International Mobile Telecommunication-200 (IMT-200) standard is realized, a high-speed data communication can be realized in addition to a voice communication. A mobile communication terminal performing data communication can process packet data and image data (for example, picture data and pixel data).

Also, the mobile communication terminal comprises a display section which will probably increase in size in the future. Also, mobile communication terminals have appeared on the market, which are capable of displaying image data received-from a base station or processing data photographed by a camera. The above-mentioned mobile communication terminal can also receive and display a television image. In order to display a television image, the mobile communication terminal must further have a television signal reception function. Also, it is required that such a mobile communication terminal be able to perform a communication function either simultaneously while processing television signals or independent of the processing of television signals.

Therefore, methods for receiving and reproducing a television signal (that is, operation in a television mode) simultaneously while performing a voice communication or a data communication (that is, operation in a communication mode) have been proposed.

However, while the conventional mobile communication terminals reproduce a moving image, they can be used only in communication but cannot be used in other work such as editing according to users' preferences. That is, in the conventional mobile communication terminals, other necessary operations can be performed only after the reproduction of the moving image, and functions for such works are now being added one by one.

Therefore, a mobile terminal capable of performing other desired functions simultaneously while reproducing a moving image is highly required.

### SUMMARY OF THE INVENTION

Accordingly, the present invention has been made to solve problems occurring in the prior art, and an object of the present invention is to provide an apparatus and method for transmitting a received television signal in a mobile communication terminal capable of receiving the television signal.

Also, another object of the present invention is to provide an apparatus and method for capturing and transmitting a received television signal in a mobile communication terminal capable of receiving the television signal.

Also, still another object of the present invention is to provide an apparatus and method for capturing and transmitting a moving image signal which is being reproduced in a mobile communication terminal capable of reproducing the moving image.

Also, still another object of the present invention is to provide an apparatus and method for capturing a moving image, which is being reproduced, and transmitting the captured image from phone to phone. Also, still another object of the present invention is to provide an apparatus and method for capturing a moving image, which is being reproduced, and transmitting the captured image together with an email.

In order to substantially accomplish these objects, there is provided an apparatus for transmitting a television signal in a mobile communication terminal capable of receiving the television signal. The apparatus comprises an input section for generating signals for capturing and transmitting a received television signal; a control section for generating, according to the signals generated by the input section, a command signal for capture and transmission of the received television signal, the control section controlling the received television signal to be displayed and simultaneously the displayed image to be captured and transmitted; a memory for storing the television signal captured according to a capture command generated by the control section; and a transmission section for transmitting the captured image stored in the memory.

In accordance with another aspect of the present invention, there is provided a method for transmitting a television signal in a mobile communication terminal capable of receiving the television signal. The method comprises the steps of video-processing and displaying the received television signal; capturing the displayed image; and transmitting the captured image.

According to a first embodiment of the present invention, there is provided a method for transmitting a television signal in a mobile communication terminal capable of receiving the television signal. The method comprises the steps of video-processing and displaying the received television signal; capturing a still image of the displayed image; and transmitting the captured still image.

According to a first embodiment of the present invention, there is provided a method for transmitting a television signal in a mobile communication terminal capable of receiving the television signal. The method comprises the steps of video-processing and displaying the received television signal; capturing a moving image for a capture time according to a capture start command and a capture end command of the displayed moving image; and transmitting the captured moving image.

In accordance with still another aspect of the present invention, there is provided an apparatus for transmitting a signal of a moving image in a mobile communication terminal capable of reproducing the moving image. The apparatus comprises an input section for generating signals for capturing and transmitting a moving image signal which is being reproduced; a control section for generating, according to the signals generated by the input section, a command signal for capture and transmission of the moving image signal which is being reproduced, the control section controlling the moving image signal to be displayed and simultaneously the displayed image to be captured and transmitted; a memory for storing the image captured according to a capture command generated by the control section; and a transmission section for transmitting the captured image stored in the memory.

In accordance with still another aspect of the present invention, there is provided a method for transmitting a signal of a moving image in a mobile communication terminal capable of reproducing the moving image, the method comprises the steps of video-processing and reproducing the moving image signal; capturing an image which is being reproduced; and transmitting the captured image.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a construction of a mobile communication terminal transmitting a television signal according to an embodiment of the present invention;

FIG. 2 is a detailed block diagram illustrating a connection between elements for receiving a television signal and a control section shown in FIG. 1;

FIG. 3 is a detailed block diagram illustrating the construction of an image processing section shown in FIGS. 1 and 2;

FIG. 4 is a timing view illustrating operation characteristics of the control section and the image processing section shown in FIGS. 2 and 3;

FIG. 5 is a view illustrating a display area of a television image signal in a display section shown in FIG. 1;

FIG. 6 is a block diagram illustrating the construction of a keypad and the display section shown in FIG. 1;

FIG. 7 is a flowchart illustrating a transmission process of a television signal according to an embodiment of the present invention;

FIG. 8 is a diagram illustrating the states of the display section when a still image is transmitted according to a first embodiment of the present invention;

FIG. 9 is a diagram illustrating the states of the display section when a moving image is transmitted according to a second embodiment of the present invention; and

FIG. 10 is a block diagram illustrating a menu serviced under a television reception mode in FIG. 7.

### DETAILED DESCRIPTION OF THE PREFERRED EMBODIMENTS

Hereinafter, an apparatus and method for transmitting a television signal received in a mobile communication terminal according to embodiments of the present invention will be described with reference to the accompanying drawings. In the following description of the present invention, a detailed description of known functions and configurations incorporated herein will be omitted for conciseness. It is to be noted that the same elements are indicated with the same reference numerals throughout the drawings.

In the following description, specific details—such as the number of pixels in one frame, the number of pixels which can be displayed in a display section, the number of pixels of a scaled image, the number of display characters of user data, comprehension methods of a still image and a moving image, transmission lines among each element and so forth—will be shown so as to aid in the overall comprehension of embodiments of the present invention. However, it will be understood by those skilled in the art that the embodiments of the present invention can be easily practiced without the specific details or by various changes of the details.

Meanwhile, a term “capture” employed in the description of embodiments of the present invention has various meanings. That is, the term “capture” signifies not only temporary storage of a still image but also temporary storage of a moving image in a predetermined section.

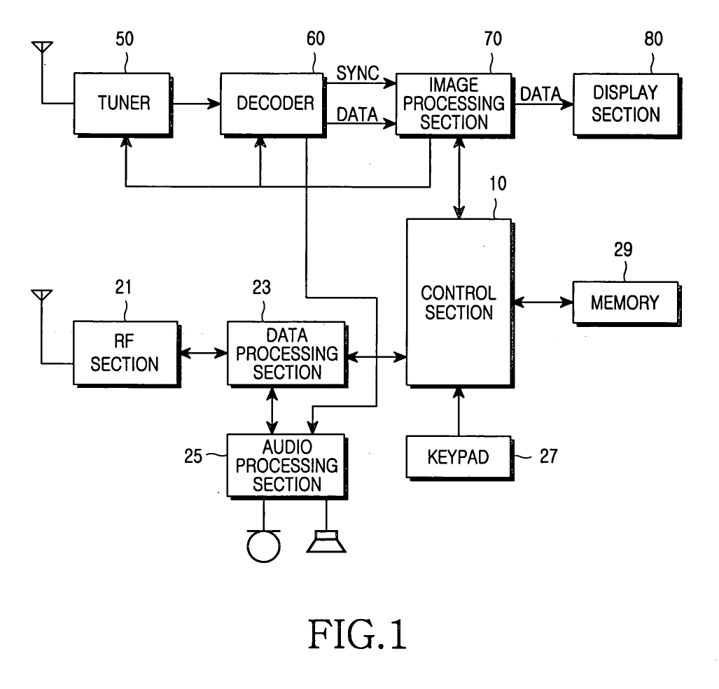

FIG. 1 is a block diagram illustrating a construction of a mobile communication terminal according to an embodiment of the present invention. Herein, the mobile communication terminal may be a mobile telephone.

Referring to FIG. 1, the mobile communication terminal comprises a tuner 50, a decoder 60, an image processing section 70, and a display section 80 to receive a television broadcasting signal. Also, the mobile communication terminal comprises an RF section 21, a data processing section 23, an audio processing section 25, a control section 10, and a keypad 27 to perform a communication and data transmission/reception function which is a basic function.

Meanwhile, an antenna connected to the tuner 50 for receiving the television broadcasting signal and an antenna connected to the RF section 21 for performing a communication function can be realized by one antenna. In one of the embodiments of the present invention, the two antennas are separately illustrated for convenience of description.

According to one embodiment of the present invention, when a television broadcasting signal received through an antenna and the tuner 50 is displayed in the display section 80, the mobile communication terminal can simultaneously capture the displayed video image and transmit the captured image using the communication and data transmission/reception functions. That is, the above-mentioned multitasking is possible because both a television mode for the reception of the television broadcasting signal and a communication mode for communication and data transmission/reception can be processed simultaneously by the elements illustrated as respective function blocks. Also, the two modes are controlled respectively by an image processing section in the control section 10, which will be described later, allowing a television image to be received and displayed in real time while being captured, recorded and transmitted.

Hereinafter, the construction of a transmission apparatus shown in FIG. 1 according to the present invention will be described in more detail.

The RF section 21 performs a radio communication of the mobile communication terminal. The RF section 21 includes an RF transmitter (not shown) for upconverting and amplifying the frequency of a transmission signal, and an RF receiver (not shown) for low-noise-amplifying a received signal and downconverting a frequency thereof. The data processing section 23 comprises a transmitter (not shown) for encoding and modulating the transmission signal, and a receiver (not shown) for demodulating and decoding the received signal. That is, the data processing section 23 may be realized by a modulator/demodulator (MODEM) and a coder/decoder (CODEC). A captured television image is encoded by the data processing section 23, and is transmitted through the RF section 21.

The audio processing section 25 reproduces a reception audio signal output from the data processing section 23 and transmits a transmission audio signal generated from a microphone to the data processing section 23. Also, in the television mode, the audio processing section 25 reproduces an audio signal of a television signal output from a decoder 60 which will be described later.

The keypad 27 comprises keys for inputting numeral and letter information, and function keys for selecting a variety of functions. Also, the keypad 27 comprises a variety of mode set keys for capturing, transmitting, and storing a television image to be displayed according to an embodiment of the present invention. Particularly, in the case of capturing a moving image, mode sets for a capture start command and a capture end command are added.

A memory 29 may comprise a program memory (not shown) and a data memory (not shown). The program memory can store programs for controlling general operations of the mobile communication terminal and programs for processing a television image signal according to an embodiment of the present invention. Also, the data memory temporarily stores data generated during the performance of the programs.

That is, a still image and a moving image captured according to one of the embodiments of the present invention are stored in the data memory 29 temporarily or permanently.

Meanwhile, the image processing section 70 constructs a moving image according to a received television signal based on the unit of frames, temporarily stores the constructed image in memory, and transmits the image to the display section 80. Also, the image processing section 70 reads data of a previously stored frame and outputs the read data to the display section, and also stores data of a current frame. As described above, since data of every frame are stored and read in real time through a memory included separately in the image processing section 70, the memory 29 connected to the control section can be utilized as a memory for storing the data of the frames.

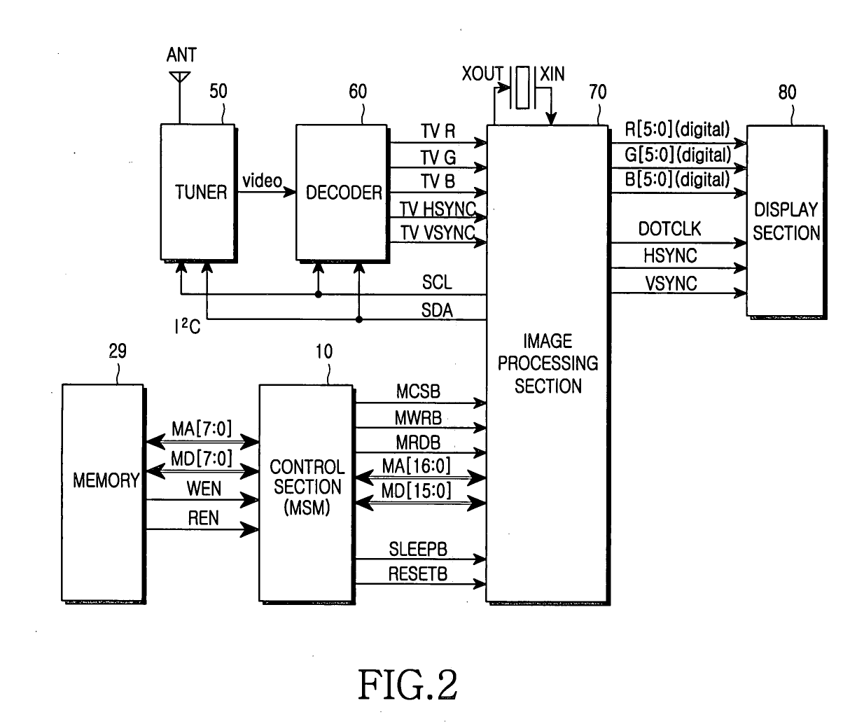

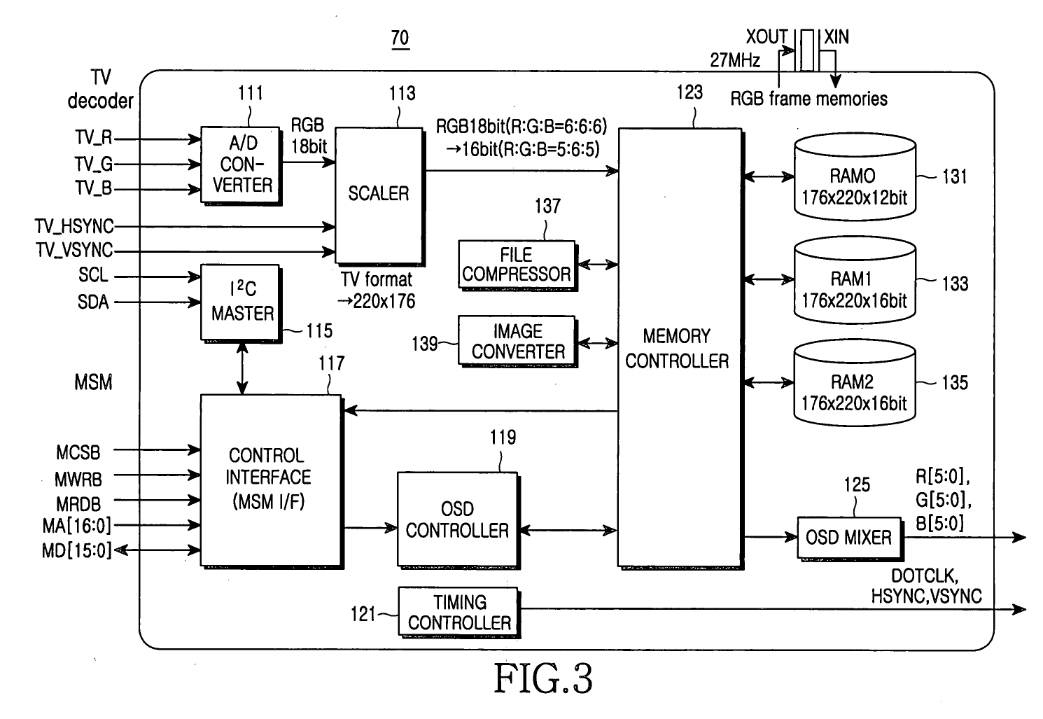

When a still image is transmitted according to an embodiment of the present invention, data of one frame temporarily stored in real time in the image processing section 70 can be transmitted directly without being separately stored in the memory 29. The process in the image processing section 70 will be explained later in more detail with reference to FIGS. 2 and 3.

The control section 10 controls the overall operation of the mobile communication terminal. Also, the control section 10 may include the data processing section 23. According to an embodiment of the present invention, when the control section 10 receives a capture or a transmission command from the keypad 27 while a television image is displayed (that is, in a television mode), the control section 10 controls the television image to be displayed and simultaneously captured or transmitted (that is, operation of a communication mode).

When the mobile terminal is in the television mode, the control section 10 controls the image processing section 70 to display a television image received according to the determined television mode, and simultaneously outputs a user data set of the television mode to the image processing section 70. Also, when the mobile terminal is in the communication mode, the control section 10 controls the image processing section 70 to operate in a television mode or in an On Screen Display (hereinafter, referred to as “OSD”) mode, and outputs a user data set of the communication mode to the image processing section 70. Also, if the mobile terminal is in a voice communication mode, the control section 10 blocks the path of a television audio signal output from a decoder 60, thereby controlling the voice communication to be performed.

The tuner 50 receives a television image signal of a selected channel under the control of the control section 10, and frequency-converts a received television image signal. The decoder 60 demodulates and decodes a composite image signal for a television in which the composite image signal is output from the tuner 50. The decoder 60 divides the composite image signal into a voice and an image signal, decodes the divided voice signal and image signal, transmits the decoded voice signal to the audio processing section 25, and transmits the decoded image signal to the image processing section 70. Also the decoder 60 decodes the television image signal, and then outputs color signals (e.g., R, G, and B) and synchronizing signals (e.g., a vertical synchronizing signal and a horizontal synchronizing signal).

The image processing section 70 communicates data with the control section 10, and performs signal processing by displaying user data output from the control section 10 and a television image signal output from the decoder 60 according to a television mode or a communication mode determined by the control section 10. If the mobile terminal is in the television mode, the image processing section 70 processes an image signal output from the decoder 60 and user data output from the control section 10, and outputs the processed signals to a corresponding area of the display section 80.

Herein, the user data includes current time, battery residual power display, reception sensitivity, and so forth, and also includes state data according to state changes of the television mode. The image processing section 70 processes and outputs the television signal with a frame size, and classifies and outputs the television image data and the user data, respectively. Also, the image processing section 70 can perform the television mode or the OSD mode, simultaneously with the communication mode.

That is, in a case of performing the communication mode while in the television mode, the image processing section 70 outputs television image data, and simultaneously outputs user data of the communication mode output from the control section 10. Also, when performing the communication mode while in the OSD mode, the image processing section 70 blocks the television image data, and controls the user data of the communication mode output from the control section 10 to be displayed. The user data may be a letter message, subscriber information, and the like.

The display section 80 displays data output from the control section 10 when the communication terminal is in the communication mode, and displays television image and user data output from the image processing section 70 in respective corresponding areas when the communication terminal is in the television mode. When the communication terminal is in the television mode, the display section 80 displays a television image output from the image processing section 70 in a first display area, and displays user data in a second display area.

Also, the display section 80 can have a third display area, and the third display area can be utilized as an area displaying soft keys, such as a menu, and so forth. For the communication mode, if the mobile communication terminal is in the television mode, the display section 80 displays a television image in the first display area and displays in the second display area user data associated with a caller in relation to the communication mode, and if the mobile communication terminal is in the OSD mode, the display section 80 displays in the first and the second display area user data associated with a caller in relation to the communication mode.

Herein, the display section 80 is realized by a liquid crystal display (LCD). The display section 80 can comprise a LCD controller, a memory in which image data can be stored, LCD display elements, and so the like. Herein, if the LCD is realized by a touch screen mechanism, the LCD together with the keypad can be the input section.

FIG. 2 is a block diagram illustrating a construction of the television receiver of the construction shown in FIG. 1.

When a user selects a television mode, the control section 10 informs the image processing section 70 of the selected mode. Then, the image processing section 70 outputs control data for selecting a channel to the tuner 50, and drives the decoder 60. Subsequently, the tuner 50 is synchronized with a channel corresponding to the channel control data output from the image processing section 70, receives and frequency-converts a television image signal received through the synchronized channel, and outputs the frequency-converted signal to the decoder 60.

The decoder 60 decodes the television image signal received from the tuner 50, and outputs a RGB analog image signal and synchronizing signals (a horizontal and a vertical synchronizing signal). The decoder 60 separates color signals from received composite image signals, and outputs the separated color signals. Herein, the decoder 60 can be realized by an NTSC decoder.

The image processing section 70, which receives a RGB image signal and synchronizing signals output from the decoder 60, adds user data to the television image signal, and then displays the television image together with the added user data in the display section 80. In this case, the user data can be user data output from the control section 10. Also, the user data may be generated from the image processing section 70 under the control of the control section 10. The above-mentioned user data are displayed on the television image in On Screen (that is, OSD).

The image processing section 70 receives an RGB analog television image signal, converts the received analog image signal into digital data by a built-in analog-to-digital converter (A/D converter), and outputs the digital data to the display section 80. Also, the image processing section 70 can display user data output from the control section 10 or user data generated from the inside under the control of the control section 10 in OSD, and has a capture function of the displayed television screen and a block copy function of OSD.

When receiving a capture command while the mobile terminal is in a television mode as described above, the control section 10 informs the image processing section 70 of the generation of the capture command. Then, the image processing section 70 displays a received television image in the first display area of the display section 80, and simultaneously displays a menu related to the capture command in the second display area. Also, when a television image signal is displayed in an enlarged state in the first and the second display area of the display section 80, the image processing section 70 reduces and displays the television image to the first display area, and displays a menu related to the capture command in the second display area.

Also, an image captured according to the capture command is transmitted from the image processing section 70 and stored in the memory 29 under the control of the control section 10.

FIG. 3 is a detailed block diagram illustrating the construction of an image processing section 70 shown in FIGS. 1 and 2, and FIG. 4 is a timing diagram illustrating data access timing between the control section 10 and the image processing section 70.

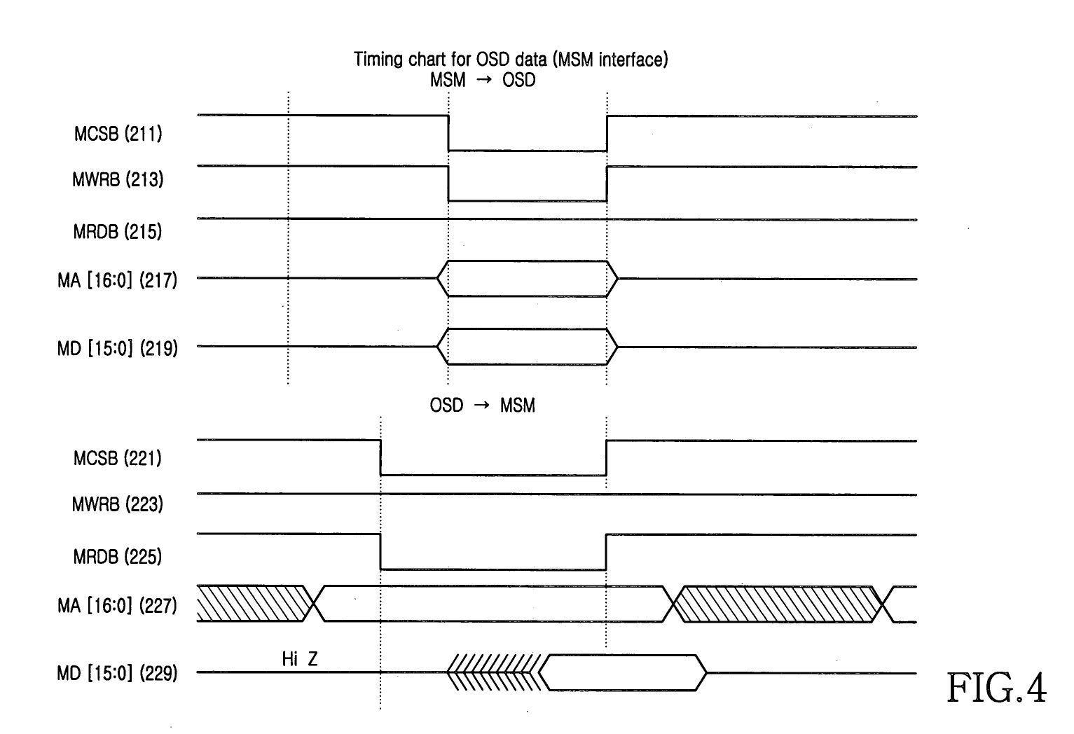

Referring to FIGS. 3 and 4, the operation of the image processing section 70 will be described as follows. An A/D converter 111 converts an RGB analog signal output from the decoder 60 into digital data. Herein, it is assumed that the A/D converter 111 converts the RGB analog signal into 18-bit RGB digital data (655536 colors).

A scaler 113 receives RGB digital data output from the A/D converter 111, and a horizontal synchronizing signal HSYNC and a vertical synchronizing signal VSYNC output from the decoder 60, and then performs a scaling operation on the RGB digital data on the basis of the synchronizing signals. The scaling operation is as follows. First, the scaler 113 determines the size of a display image. Second, from the determined size of the display image, a horizontal and a vertical size VXSIZE and VYSIZE are determined.

In an embodiment of the present invention, it is assumed that the television image signal is scaled by dimensions from a maximum 220×176 pixels to a minimum 100×75 pixels. Third, a scaling rate (enlargement ratio/reduction ratio) is determined. Fourth, ‘720×4096/VXSIZE’ is calculated about a horizontal direction and the calculated value is determined as ‘HLSR’, and ‘240×2048NVYSIZE’ is calculated about a vertical direction and the calculated value is determined as ‘VLSR’. In an embodiment of the present invention, it is assumed that an input image signal is scaled by dimensions to maximum 220×176 pixels. Also, the scaler 113 converts the 18-bit RGB data into 16-bit RGB data. Herein, the 16-bit RGB data [15:0] can comprises 5-bit Red (R) data [15:11], 6-bit Green (G) data [10:5], and 5-bit Blue (B) data [4:0].

Data of a frame size (176×220×12 bits) are stored in memories 131, 133, and 135. When the mobile terminal is in a television mode, the memory 131 is used to store user data, and the memories 133 and 135 are used to store image data. Also, when the mobile terminal is in an OSD mode, the memories 131 and 133 are used to store user data, and the memory 135 is used to store a background screen data.

A memory controller 123 controls access to the memories 131, 133, and 135 under the control of the control section 10. The memory controller 123 controls the memories 131, 133, and 135 separately according to a television mode or an OSD mode. First, in a television mode, the memory controller 123 accesses user data output from the control section 10 into the first memory 131, stores current frame image data output from the scaler 113 into the second memory 133 (or the third memory 135), and outputs the previous frame image data stored in the third memory 135 (or the second memory 133).

The memory controller 123 stores and outputs received television RGB image data by the unit of frame in the memories 133 and 135. If current frame image data are stored in the second memory 133, previous frame image data stored in the third memory 135 are output, and if current frame image data are stored in the third memory 135, previous frame image data stored in the second memory 133 are output. That is, when accessing data to the memories 133 and 135, the memory controller 123 stores received frame data and simultaneously outputs stored frame data, so that television image signals are processed in real time.

That is, since 30 frames per second must be processed when a television image is displayed, image signals are transmitted to the display section 80 in real time using two frame memories. Also, the memory controller 123 outputs frame image data to the display section 80 during a frame period (a vertical synchronizing signal period), and outputs user data stored in the first memory 131 in an idle period before the next frame is processed. In other words, the memory controller 123 outputs frame image data stored in the memory 133 or 135 during each frame period (one vertical synchronizing signal period), in which an image signal exists, and outputs user data stored in the memory 131 during the idle period.

Secondly, in an OSD mode, the memory controller 123 uses the first and second memory 131 and 133 for the purpose of accessing user data, and uses the third memory 135 for the purpose of storing background screen data. Only one, not both, of the memories 131 and 133 may be set and used.

An OSD mixer 125 mixes the user data and image data of a frame size with each other, which are output from the memory controller 123, as On-Screen data, and then outputs the mixed data to the display section 80. A timing controller 121 generates a pixel clock DOTCLK and synchronizing signals (a horizontal synchronizing signal HSYNC and a vertical synchronizing signal VSYNC) which are detected in a television mode. The timing controller 121 synchronizes image data pixels, line image data, and frame image data output from the OSD mixer 125 with each other and then outputs them to the display section 80.

A control interface 117 interfaces user data and mode control data between the control section 10 and the image processing section 70. In an embodiment of the present invention, the control interface 117 in the image processing section 70 interfaces a 17-bit address and 16-bit data with the control section 10. A frame memory of the image processing section 70 is accessed when the highest bit (A16) of the address is ‘1’, and a resister of the image processing section 70 is accessed when he highest bit (A16) of the address is ‘0’.

Referring to FIG. 4, first, when outputting data to the image processing section 70, the control section 10 selects the image processing section 70 as indicated by a reference number 211, and activates a write mode as indicated by a reference number 213. Also, The control section 10 outputs an address MA[16:0] as indicated by a reference number 217 and user data MD[15:0] as indicated by a reference number 219, thereby recording user data in the image processing section 70. The user data may be data, such as current time, battery residual power, reception sensitivity, and the like, control data for television screen control and mode set, menu data, and the like.

Secondly, when accessing data from the image processing section 70, the control section 10 selects the image processing section 70 as indicated by a reference number 221, and activates a read mode as indicated by a reference number 225. Also, The control section 10 outputs an address MA[16:0] as indicated by a reference number 227, thereby accessing user data MD[15:0] of a corresponding address as indicated by a reference number 229. The control interface 117 performs an interface function so that the image processing section 70 can process the output of the control section 10 shown in FIG. 4.

An Inter-Integrated Circuit (12C) interface 115 has an 12C bus master capable of controlling two slave devices. The 12C interface 115 controls the tuner 50 and the decoder 60, and is controlled by the control interface 117.

An OSD controller (e.g., OSD RAM Block Copy Accelerator) 119 can copy any rectangular area of the user data in any position. The OSD controller 119 can block-copy data of any rectangular area in any position of a displayed image screen, by control data of the control section 10 output from the control interface 117. The copy function can be performed in a memory or between memories. When the mobile terminal is in the television mode, the block copy can be performed only in the first memory 131, while when the mobile terminal is in the OSD mode, the block copy can be performed in the first memory 131, in the third memory 133, and between the two memories 131 and 135.

Also, in order to realize one of the embodiments of the present invention, the image processing section 70 further comprises a file compressor 137 and an image converter 139. The file compressor 137 and the image converter 139 function to compress and convert a captured image according to the control of the memory controller 123.

To be more specific, frame image data converted through the scaler 113 are stored in the memory 131 by the unit of frame in real time as described above, and a process to compress the frame image is required when the image is captured and transmitted according to one of the embodiments of the present invention. The image compression is performed in the file compressor 137.

Meanwhile, when moving image data are captured and transmitted, images are stored in the memory 131 and read from the memory 131 by the unit of frame, so that the frame data must be accumulated and separately stored. In this case, the accumulated and stored moving image is compressed through the file compressor 137.

When captured data are still image data, the file compressor 137 can compress the data selected from the group of file extensions consisting of Joint Photographic Experts Group (JPEG), BitMap (BMP), Graphics Interchange Format (GIF), Picture Image Compression (PIC), Tag Image File Format (TIFF), Portable Document Format (PDF), and Extension Post Script graphics (EPS) formats. Also, when captured data are moving image data, the file compressor 137 can compress the data selected from the group of file extensions consisting of Moving Pictures Expert Group (MPEG), Advanced Streaming Format file (ASF), Advanced Streaming Redirect file (ASX), AVI, Data file for video CD MPEG movie (DAT), Animator Animation (FLI), Animator Animation most recent version of FLI format (FLC), Apple QuickTime Movie (MOV), MPEG Movie (MPG), Real Audio (RA), Real Media (RAM), Real Media (RM), MPEG layer 2 movie (VOB), and Vivo Active Movies (VIV) formats.

When captured data for transmission are still image data, the image converter 139 converts the size of the image to fit with the display size of a receiving mobile communication terminal. For example, the frame image data are converted into 128×12 dots or 128×96 dots size according to the standard of a mobile communication supplier.

Still image data converted in the image converter 139 may be transmitted without compression. For example, if a receiving terminal does not decompress image data, it is preferred that the still image is transmitted without compression.

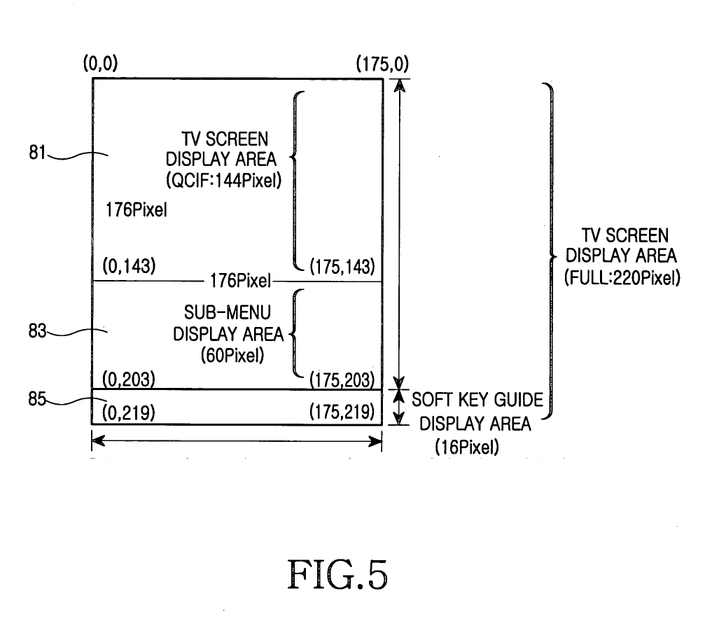

FIG. 5 is a view illustrating the display area of the display section 80 shown in FIG. 1. The display section 80 has a first display area 81 for displaying a television image received in a television mode and a second display area 83 for displaying user data. Also, the display section 80 may further comprise a third display area 85 in which a soft key information for the setting of a television mode and an OSD mode is displayed. In an embodiment of the present invention, the first display area 81 (or the first and second display area) is used to display a television image, and the third area 85 is used to display a menu for capture and transmission of a television image.

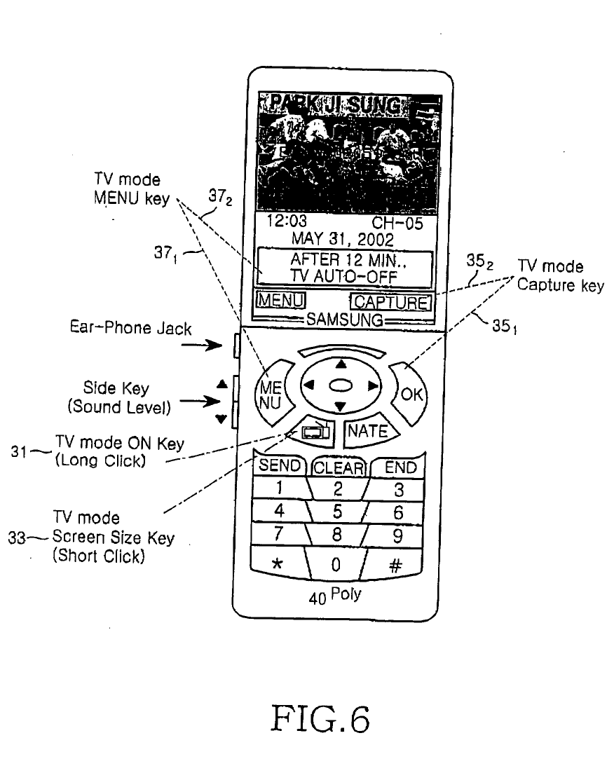

FIG. 6 is a diagram illustrating an example of the construction of the keypad 27 and the display section shown 80 according to an embodiment of the present invention. In the construction of the keypad 27, a TV-mode ON key 31 sets a mobile communication terminal to a television mode. When a TV key is pressed for a long period of time, the control section 10 detects the long input of the key as the operation of the TV-mode ON key 31. Also, a TV-mode screen size key 33 switches the size and direction of a screen displayed in the display section 80. When the TV key is pressed for a short period of time, the control section 10 detects the short input of the key as the operation of the TV-mode screen size key 33.

An embodiment of the present invention shows an example in which the TV-mode ON key and the TV-mode screen size key are realized by one key, but it should be appreciated by those skilled in the art that the TV-mode ON key and the TV-mode screen size key may be independently realized by respective keys. A TV-mode capture is detected by the control section 10 when an OK key 35₁ or a capture key 35₂ is pressed when a TV screen signal is being displayed according to the setting of the television mode. Menu keys 37₁ and 37₂ function to set a television mode, and to control channels, screen, timer, and the like when the television mode has been set.

According to the present invention, when a capture key 35₂or an OK key 35₁ is pressed when the mobile terminal is in a television mode, a capture mode is performed. In the capture mode, a still image or a moving image can be captured according to two embodiment of the present invention. According to the detail functions of the embodiments, respective detail functions are displayed in the display section. Detail functions according to the embodiments of the present invention will be described later.

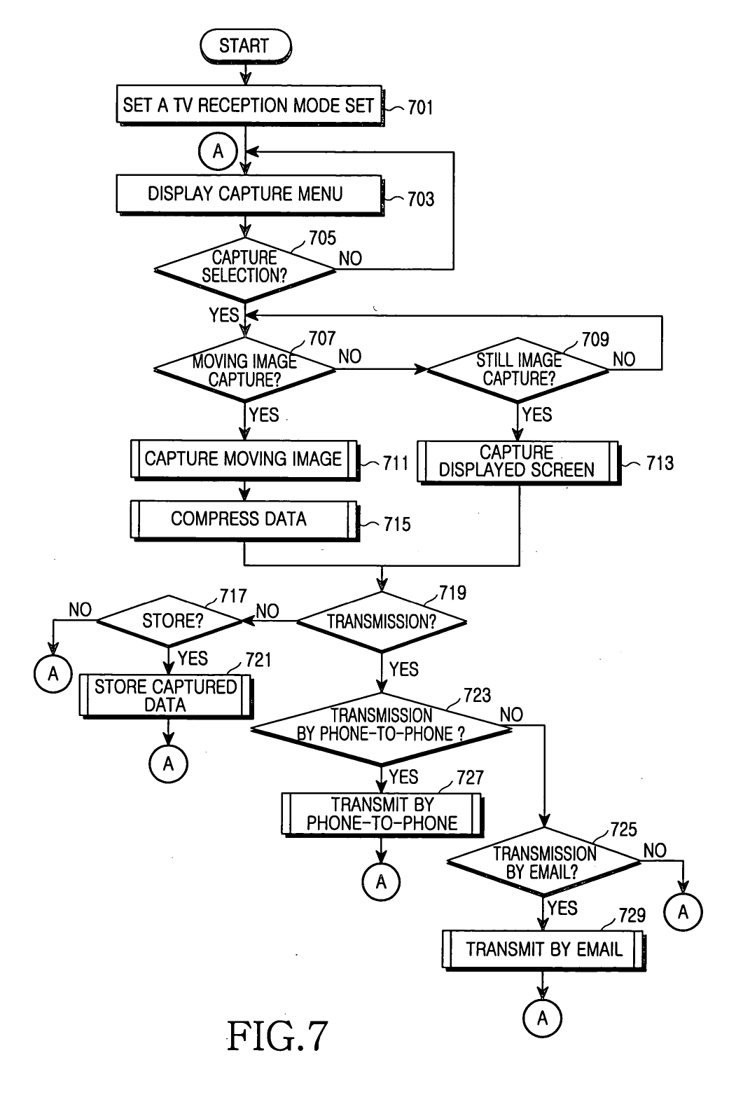

FIG. 7 is a flowchart for explaining a process of capturing and transmitting a received television signal according to an embodiment of the present invention.

Referring to FIG. 7, first, at step 701, a television reception mode is set, a received television image is displayed through the display section of the mobile communication terminal.

At the state of performing the television mode, a capture menu is displayed at step 703. When a screen capture key is operated with reference to the displayed capture menu, the control section 10 detects this at step 705, and displays a select menu for selecting one of a still image capture and a moving image capture.

If the still image capture of the select menu is selected at step 709, a still image which is being displayed is captured at step 713. At this time, in order to edit or confirm the captured still image, the displayed image can be stopped in the instant the displayed image is captured. As another method, it is possible that even though a currently displayed image is captured, a television moving image is continuously displayed, while a lower menu is changed into a store or a transmission menu so that the performance of a capture command can be judged.

If a moving image capture is selected in the select menu, both a capture start time and a capture end time of a currently displayed moving image are determined at step 711, thereby enabling the moving image to be captured for the determined time. That is, a user determines a capture start time and a capture end time through a key input of the mobile terminal while showing moving images displayed in real time. It is possible that when a moving image capture is selected in the select menu it is set as a capture start time of the moving image, and a user determines only a capture end time. In this case, it is preferred that the television image is displayed in the first display area which has nothing to do with the capture operation.

The captured moving image is compressed at step 715. Since the captured moving image has a large amount of data compared to general data, it is preferred to store and transmit the file after compression. The compression can be performed and selected from the group of file extensions consisting of MPEG, ASF, ASX, AVI, DAT, FLI, FLC, MON, MPG, RA, RAM, RM, VOB, and VIV formats, and it should be apparent to those skilled in the art that the embodiments of the present invention are not limited to the cited extensions and that any other moving image compression format can be applied to the present invention.

The captured still image or moving image can be transmitted and stored according to the embodiments of the present invention. Meanwhile, according to the embodiments of the present invention, it is preferred that transmission and storage of the image performed while a user watches the television image in real time.

That is, in this mobile communication terminal, a television image is displayed through the first display area of the display section so that a user can watch the television image, and simultaneously the transmission and the storage of the television image can be performed through another display area (for example, the second display area or the third display area) of the display section.

When the capture of a still image or a moving image is terminated, a store and transmission menu is displayed in the display section. Subsequently, when a store menu is selected at step 717, the captured data are stored at step 721.

Meanwhile, according to the present invention, a transmission menu is selected at step 719, a menu enabling any one of a phone-to-phone transmission and an email transmission is displayed. When the phone-to-phone transmission of the menu is selected at step 723, the captured image is transmitted according to a general phone-to-phone transmission method at step 727.

Also, when the email transmission of the menu is selected at step 725, the captured image is transmitted according to a general email transmission method at step 729.

Hereinafter, the transmission methods will be described in more detail. The transmission of a television still image and a television moving image can be realized by a plurality of methods. Meanwhile, since a transmission process of the image refers to a data transmission toward an object terminal, a process according to a communication mode must be performed, and simultaneously a television mode as described above must be performed.

Also, the image data can be transmitted directly to a reception terminal after a data channel is set with the reception terminal, and can also be downloaded to a reception terminal according to the request of a receiver after the image data is stored temporarily in a server of a service provider.

A method of storing the image data in a server of a service provider and transmitting the stored data will be described as follows. When the image data are transmitted with a telephone number of a reception terminal, the image data and the telephone number of the reception terminal are stored in a server of a service provider. The service provider informs the reception terminal that image data to be transmitted from a transmission terminal is waiting to be delivered to the reception terminal. Informing the reception terminal that reception data exists may be realized by a short message service (SMS).

The reception terminal receives information that image data is to be received. The reception terminal is connected to the service provider, and the service provider downloads the image data.

Hereinafter, described will be another method in which image data are transmitted together with an email. The transmission terminal inputs or selects an email address for a reception terminal through the selection of an email transmission menu, and transmits an email message with which the image data are appended.

When the image data, which are appended with an email message, are transmitted as described above, the receiving-side can receive the email message and the appended image data through a mobile communication terminal and/or a general computer terminal linked to on-line environment.

Meanwhile, when a still image is transmitted from phone to phone as described above, the display size of a reception terminal may differ from the display standard of a network service provider. Therefore, the still image must be converted into an appropriate size (for example, 128×12 or 128×96 dots) through the image converter 139.

However, when a file is transmitted through an email, it is not necessary to convert the display size into the display size required by a network service provider, so that it is possible to compress and transmit data in the own size (for example, 128×160 dots). Also, when data are transmitted through an email, the transmission is performed after additional processes, such as object, contents, appending, and so forth. Meanwhile, an email address for the receiving-side may be directly input or may be selected through the search of stored addresses, according to the construction of a menu.

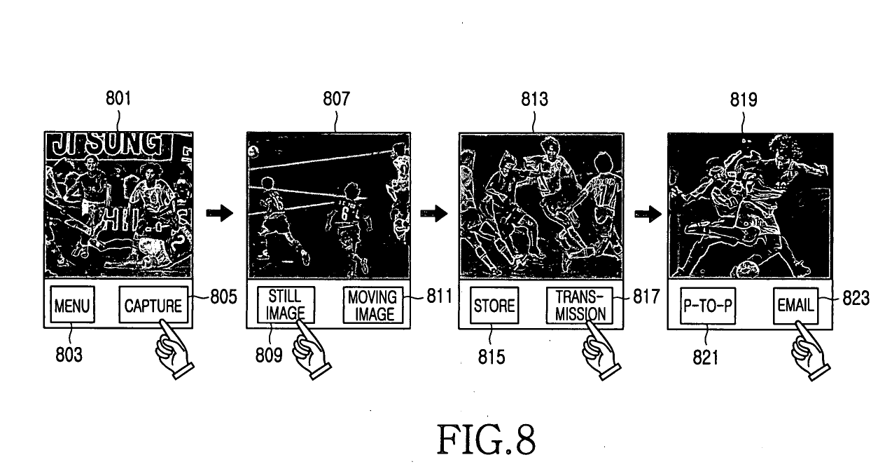

FIG. 8 are block diagrams illustrating the states of the display section when a still image is transmitted according to a first embodiment of the present invention.

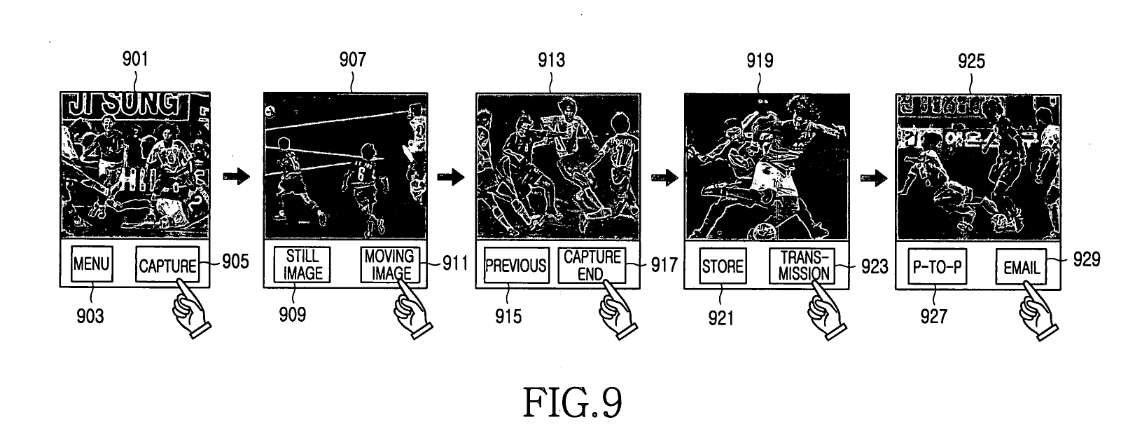

FIGS. 8 and 9, which will be described later, are views illustrating display sections of a mobile communication terminal. For convenience of explanation, a first display area to display a television moving image and a second display area to display a menu to enable a capture function according to the present invention to be performed are shown in a simplified form in FIGS. 8 and 9.

Also, FIGS. 8 and 9 show that each menu is selected and performed according to the embodiments of the present invention and simultaneously television moving images are displayed in real time.

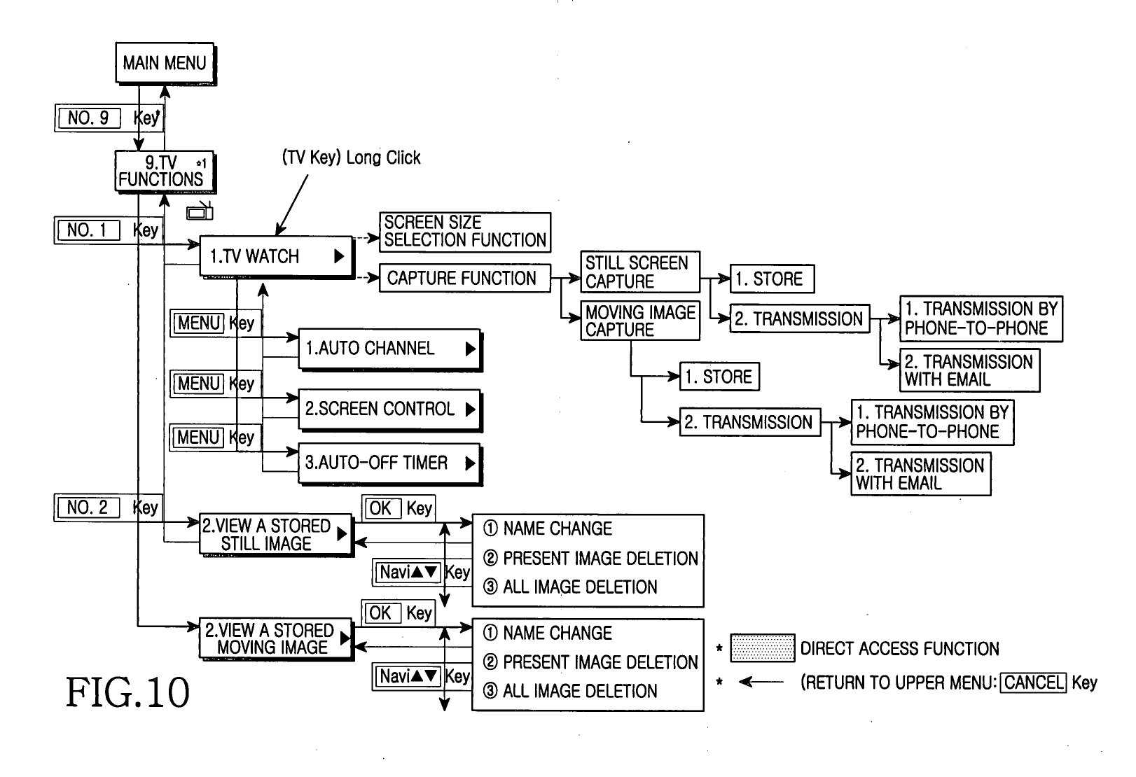

Referring to FIG. 8, in Screen 801, a television moving image is displayed in the first display area in real time, and buttons for selecting one of a menu 803 and a capture 805 are displayed in the second display area located below. It is preferred that the menu button 803 is linked to functions related to a television mode of a mobile communication terminal, the detailed explanation of the menu will be described with reference to FIG. 10 later.

If the capture button 805 is selected, a selection menu for selecting one of a still image 809 and a moving image 811 is displayed as shown in Screen 807. If the button of the still image 809 is selected in the Screen 807, the image of the still image displayed in the instant of selecting the button of the still image 809 is captured. Also, it is preferred that the still image captured in the instant of selecting the button of the still image 809 is stored separately in a temporary memory, and that the embodiments of the present invention are realized so that the television moving images are continuously displayed regardless of the capture process used.

When the button of the still image 809 is selected and a still image is captured, a store button 815 and a transmission button 817 are displayed as shown in Screen 813. Next, the store button 815 is selected, a still image which has been captured and temporarily stored in a memory is stored in a predetermined memory area and maintained. In this case, it is apparent to those skilled in the art that a menu can be added so as to provide the captured image with a file name.

Meanwhile, when the transmission button 817 is selected in the Screen 813, a selection menu for selecting one of a phone-to-phone transmission 821 and an email transmission 823 is displayed as shown in Screen 819.

According to the section of the phone-to-phone transmission 821 and the email transmission 823, the data of the still image captured as described above are transmitted.

FIG. 9 are diagrams illustrating the states of the display section when a moving image is transmitted according to a second embodiment of the present invention.

FIG. 9 is a view illustrating a display section of a mobile communication terminal, as described above with reference to FIG. 8. For convenience of explanation, a first display area to display a television moving image and a second display area to display a menu to enable a capture function according to the present invention to be performed are shown in a simplified form in FIGS. 8 and 9.

Also, as described above, FIG. 9 shows that each menu is selected and performed according to the embodiments of the present invention and simultaneously television moving images are displayed in real time.

Referring to FIG. 9, in Screen 901, a television moving image is displayed in the first display area in real time, and buttons for selecting one of a menu 903 and a capture 905 are displayed in the second display area located below. It is preferred that the menu button 903 is linked to functions related to a television mode of a mobile communication terminal, the detailed explanation of the menu will be described with reference to FIG. 10 later.

If the capture button 905 is selected, a selection menu for selecting one of a still image 909 and a moving image 911 is displayed as shown in Screen 907. If when the button of the moving image 911 is selected in the Screen 907, the images of the moving image displayed from the instant of selecting the button of the moving image 911 is continuously captured and stored. It is preferred that the images of the moving image captured in real time are stored separately in a predetermined memory. In this case, since images of a moving image have a relatively large amount of data, a large capacity memory is required.

When the button of the moving image 911 is selected and a capture of images of a moving image has begun, a priority button 915 and a capture end button 917 are displayed as shown in Screen 913. When the capture end button 917 is selected, only the frames until the instant of selecting the capture end button 917 are stored, and images displayed thereafter aren't captured.

Meanwhile, if moving images captured as described above are not terminated within an appropriate time because of the quantity of data, memory capacity can be exceeded. Therefore, if the image size of a moving image to be being captured reaches a predetermined size (or in a case that the image size exceeds a predetermined maximum storable time), it is preferred to terminate the capture process by automatically.

When the capture end button 917 is selected and the capture of a moving image is terminated, a store button 921 and a transmission button 923 are displayed as shown in Screen 919. Next, when the store button 921 is selected, data of a moving image which have been captured and temporarily stored in a memory are stored in a predetermined memory area and maintained. In this case, it should be apparent to those skilled in the art that a menu can be added so as to provide the captured image with a file name.

Meanwhile, when the transmission button 923 is selected in the Screen 919, a selection menu for selecting one of a phone-to-phone transmission 927 and an email transmission 929 is displayed as shown in Screen 925.

As described above, the data of the captured moving image are transmitted according to the section of the phone-to-phone transmission 927 and the email transmission 929.

FIG. 10 shows menus and roles of respective keys for servicing functions in a television mode. First, when a menu key is pressed, main menu items of a mobile communication terminal are displayed. When a television menu item is pressed, menu items of ‘watch TV’, ‘view a stored still image’, and ‘view a stored moving image’ are displayed as shown in FIG. 10. Next, the ‘watch TV’ menu is selected, menus of ‘auto channel’, ‘screen control’, ‘auto-off timer’, and so forth are displayed. When the ‘view a stored still image’ or the ‘view a stored moving image’ menu is selected, menus of ‘name change’, ‘current image elimination’, ‘whole image elimination’, and so forth are displayed.

Meanwhile, when menu keys are generated in a television mode including both cases of a Quarter Common Intermediate Format (QCIF) screen display and the whole screen display, the control section 10 commands the image processing section 70 to display the menu screen with a QCIF screen size in the display section 80. Then, the image processing section 70 outputs image data in a QCIF screen size, outputs menu items to the second display area 83, and displays soft keys in the third display area 85.

According to one of the embodiments of the present invention, when the mobile terminal is in a television mode, the capture menu can be displayed as shown in FIGS. 8 and 9 so that the capture of image linked menu buttons in the menu can be easily performed.

The capture function menu includes a still image capture menu and a moving image capture menu, and each of the capture menu includes a store menu and a transmission menu. Also, each of the transmission menus includes a phone-to-phone transmission menu and an email appending transmission menu.

It should be apparent to those skilled in the art that general menus, which are used when a file is stored, such as a file-name setting menu, can be added in the store menu as described above. Also, it should be apparent to those skilled in the art that a menu for input of a receiving-side information must be necessarily included in the transmission menu. For example, when transmitting an image together with an email, a menu for inputting an email address of a receiving-side or for selecting an email address of a receiving-side through memory search must be included, and when transmitting an image according to a phone-to-phone method, a menu for inputting a telephone number of a receiving-side or for selecting a telephone number of a receiving-side through memory search must be included.

While the detailed embodiments of the present invention have been described using examples in which a television signal is received and reproduced, it should be apparent to those skilled in the art that the present invention can be applied to the reproduction of a general moving image in a mobile communication terminal having a moving image reproduction function. For example, the present invention can be applied to communication broadcasting Service and Multimedia Broadcast/Multicast Service (hereinafter, referred to as “MBMS”) which are discussed in the third generation mobile communication, and also can be applied to the reproduction of a moving image stored in mobile communication terminal in the same way.

When reproducing a moving image by MBMS, a user may request a service provider, which provides the MBMS and a moving image, to transmit a required moving image to a specific object. However, it places a burden of additional cost. Particularly, an apparatus for capturing and transmitting a specific part of the whole moving image can be realized more efficiently using one of the embodiments of the present invention. Also, according to one of the embodiments of the present invention, when transmitting a moving image which has been stored in the mobile communication terminal, a user can capture only the required part of the moving image and simultaneously can transmit the captured part, while the moving image is being reproduced.

As described above, the present invention has advantages in that while images of a moving image are reproduced in a mobile communication terminal, a still image or the moving image can be captured in real time, and also simultaneously the captured image can be record and transmitted.

While the invention has been shown and described with reference to certain embodiments thereof, it will be understood by those skilled in the art that various changes in form and details may be made therein without departing from the spirit and scope of the invention as defined by the appended claims.

What is claimed is:

1. An apparatus for transmitting a signal of a moving image in a mobile communication terminal capable of reproducing the moving image, the apparatus comprising:
an input section for generating signals for capturing and transmitting a moving image signal which is being reproduced;
a control section for generating, according to the signals generated by the input section, a command signal for capture and transmission of the moving image signal which is being reproduced, the control section controlling the moving image signal to be displayed and simultaneously the displayed image to be captured and transmitted;
a memory for storing the image captured according to a capture command generated by the control section; and
a transmission section for transmitting the captured image stored in the memory.

2. An apparatus as claimed in claim 1, wherein the captured image includes still image data.

3. An apparatus as claimed in claim 1, wherein the captured image includes moving image data.

4. An apparatus as claimed in claim 1, further comprising a file compressor for compressing the captured image.

5. An apparatus as claimed in claim 2, wherein the file compressor compresses the still image data in one selected from the group of extensions consisting of Joint Photographic Experts Group (JPEG), BitMap (BMP), Graphics Interchange Format (GIF), Picture Image Compression (PIC), Tag Image File Format (TIFF), Portable Document Format (PDF), and Extension Post Script graphics (EPS) formats.

6. An apparatus as claimed in claim 3, wherein the file compressor compresses the moving image data in one selected from the group of extensions consisting of Moving Pictures Expert Group (MPEG), Advanced Streaming Format file (ASF), Advanced Streaming Redirect file (ASX), AVI, Data file for video CD MPEG movie (DAT), Animator Animation (FLI), Animator Animation most recent version of FLI format (FLC), Apple QuickTime Movie (MOV), MPEG Movie (MPG), Real Audio (RA), Real Media (RAM), Real Media (RM), MPEG layer 2 movie (VOB), and Vivo Active Movies (VIV) formats.

7. An apparatus as claimed in claim 1, further comprising an image converter for converting a video image size of the captured image.

8. An apparatus as claimed in claim 7, wherein the converted image size is one of dimensions including 128×112 dots and 128×96 dots.

9. An apparatus as claimed in claim 1, wherein the transmission section transmits a captured image, which is stored in the memory, by a phone-to-phone method.

10. An apparatus as claimed in claim 1, wherein the transmission section transmits a captured image, which is stored in the memory, together with an email.

11. An apparatus as claimed in claim 1, further comprising a display section which includes a first display area for video-processing and displaying the moving image signal and a second display area for displaying a user function selection menu in such a manner that the menu can be selected by the input section.

12. A method for transmitting a signal of a moving image in a mobile communication terminal capable of reproducing the moving image, the method comprising the steps of:
video-processing and reproducing the moving image signal;
capturing an image which is being reproduced; and
transmitting the captured image.

13. A method as claimed in claim 12, wherein the step of reproducing the moving image signal is performed simultaneously with the steps of capturing and transmitting the image.

14. A method as claimed in claim 12, wherein the captured image includes still image data.

15. A method as claimed in claim 12, wherein the captured image includes moving image data.

16. A method as claimed in claim 12, further comprising a step of storing the captured image in a memory after the step of capturing the image.

17. A method as claimed in claim 12, further comprising a step of compressing the captured image after the step of capturing the image.

18. A method as claimed in claim 12, wherein the file compression is performed in one selected from the group of extensions consisting of Joint Photographic Experts Group (JPEG), BitMap (BMP), Graphics Interchange Format (GIF), Picture Image Compression (PIC), Tag Image File Format (TIFF), Portable Document Format (PDF), and Extension Post Script graphics (EPS) formats.

19. A method as claimed in claim 15, wherein the file compression is performed in one selected from the group of extensions consisting of Moving Pictures Expert Group (MPEG), Advanced Streaming Format file (ASF), Advanced Streaming Redirect file (ASX), AVI, Data file for video CD MPEG movie (DAT), Animator Animation (FLI), Animator Animation most recent version of FLI format (FLC), Apple QuickTime Movie (MOV), MPEG Movie (MPG), Real Audio (RA), Real Media (RAM), Real Media (RM), MPEG layer 2 movie (VOB), and Vivo Active Movies (VIV) formats.

20. A method as claimed in claim 12, further comprising a step of converting the size of the captured image after the step of capturing the image.

21. A method as claimed in claim 20, wherein the converted image size is one of dimensions including 128×112 dots and 128×96 dots.

22. A method as claimed in claim 12, wherein the captured image is transmitted by a phone-to-phone method.

23. A method as claimed in claim 12, wherein the captured image is transmitted together with an email.

24. A method as claimed in claim 12, wherein the display step is performed in such a manner that the moving image signal, which is being reproduced, is video-processed and displayed in a first display area of a display section in a mobile communication terminal and a user function selection menu is displayed in a second display area so as to enable the menu to be selected by the input section.

25. An apparatus for transmitting a television signal in a mobile communication terminal capable of receiving the television signal, the apparatus comprising:
an input section for generating signals for capturing and transmitting a received television signal;
a control section for generating, according to the signals generated by the input section, a command signal for capture and transmission of the received television signal, the control section controlling the received television signal to be displayed and simultaneously the displayed image to be captured and transmitted;
a memory for storing the television signal captured according to a capture command generated by the control section; and
a transmission section for transmitting the captured image stored in the memory.

26. A method for transmitting a television signal in a mobile communication terminal capable of receiving the television signal, the method comprising the steps of:
video-processing and displaying the received television signal;
capturing the displayed image; and
transmitting the captured image.

27. A method for transmitting a television signal in a mobile communication terminal capable of receiving the television signal, the method comprising the steps of:
video-processing and displaying the received television signal;
capturing a still image of the displayed image; and
transmitting the captured still image.

28. A method for transmitting a television signal in a mobile communication terminal capable of receiving the television signal, the method comprising the steps of:
video-processing and displaying the received television signal;
capturing a moving image for a capture time according to a capture start command and a capture end command of the displayed moving image; and
transmitting the captured moving image.

29. An apparatus as claimed in claim 4, wherein the file compressor compresses the still image data in one selected from the group of extensions consisting of Joint Photographic Experts Group (JPEG), BitMap (BMP), Graphics Interchange Format (GIF), Picture Image Compression (PIC), Tag Image File Format (TIFF), Portable Document Format (PDF), and Extension Post Script graphics (EPS) formats.

30. An apparatus as claimed in claim 4, wherein the file compressor compresses the moving image data in one selected from the group of extensions consisting of Moving Pictures Expert Group (MPEG), Advanced Streaming Format file (ASF), Advanced Streaming Redirect file (ASX), AVI, Data file for video CD MPEG movie (DAT), Animator Animation (FLI), Animator Animation most recent version of FLI format (FLC), Apple QuickTime Movie (MOV), MPEG Movie (MPG), Real Audio (RA), Real Media (RAM), Real Media (RM), MPEG layer 2 movie (VOB), and Vivo Active Movies (VIV) formats.

31. A method as claimed in claim 17, wherein the file compression is performed in one selected from the group of extensions consisting of Joint Photographic Experts Group (JPEG), BitMap (BMP), Graphics Interchange Format (GIF), Picture Image Compression (PIC), Tag Image File Format (TIFF), Portable Document Format (PDF), and Extension Post Script graphics (EPS) formats.

32. A method as claimed in claim 17, wherein the file compression is performed in one selected from the group of extensions consisting of Moving Pictures Expert Group (MPEG), Advanced Streaming Format file (ASF), Advanced Streaming Redirect file (ASX), AVI, Data file for video CD MPEG movie (DAT), Animator Animation (FLI), Animator Animation most recent version of FLI format (FLC), Apple QuickTime Movie (MOV), MPEG Movie (MPG), Real Audio (RA), Real Media (RAM), Real Media (RM), MPEG layer 2 movie (VOB), and Vivo Active Movies (VIV) formats.
